(19) United States
(12) Patent Application Publication
(10) Pub. No.: US 2008/0250443 A1
(43) Pub. Date: Oct. 9, 2008

(54) System and method for providing communication services

(75) Inventors: James Fan, San Ramon, CA (US); Chou Lan Pok, San Ramon, CA (US); Jennifer Lam, Fremont, CA (US); Charles Fenton, Ypsilanti, MI (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/784,205

(22) Filed: Apr. 5, 2007

(51) Int. Cl. H04N 7/16; H04M 11/04

(52) U.S. Cl. 725/25; 379/37

(57) ABSTRACT

Systems and methods for providing communication services are provided. A method of providing communication services may include provisioning at least one first communication service at a network interface unit (NIU) associated with a premises. The at least one first communication service may be associated with a placeholder account. The method also includes receiving, via the at least one first communication service, a request to activate at least one second communication service. The method also includes automatically activating the at least one second communication service.

### FIELD OF THE DISCLOSURE

The present disclosure is generally related to providing communication services.

### BACKGROUND

Communication service providers may spend considerable amounts of money in efforts to attract and retain subscribers. Reducing costs associated with attracting and retaining such subscribers is generally desirable to communication service providers. Hence, there is a need for improved systems and methods for providing communication services.

### BRIEF DESCRIPTION OF THE DRAWINGS

FIG. 1 is a block diagram of a first embodiment of a system to provide communication services;

FIG. 2 is a block diagram of a second embodiment of a system to provide communication services;

FIG. 3 is a block diagram of a third embodiment of a system to provide communication services;

FIG. 4 is a flow diagram of a first embodiment of a system to provide communication services;

FIG. 5 is a flow diagram of a second embodiment of a system to provide communication services;

FIG. 6 is a flow diagram of a third embodiment of a system to provide communication services; and

FIG. 7 is a block diagram of a general computing system.

### DETAILED DESCRIPTION OF THE DRAWINGS

In a particular embodiment, a method of providing communication services may include provisioning at least one first communication service at a network interface unit (NIU) associated with a premises. The at least one first communication service may be associated with a placeholder account. The method also includes receiving, via the at least one first communication service, a request to activate at least one second communication service. The method also includes automatically activating the at least one second communication service.

In a particular embodiment, a method of providing communication services may include coupling a communication device to a network interface unit (NIU) at a location associated with the NIU. Coupling the communication device to the NIU may activate at least one first communication service. The method may also include receiving a prompt to activate at least one second communication service. The method may also include sending a response to the prompt via the at least one first communication service. The response may include a request to activate the at least one second communication service.

In a particular embodiment, a method of providing communication services may include receiving a request to deactivate at least one first communication service associated with a subscriber account. The method may also include deactivating the at least one first communication service at a network interface unit (NIU). The method may further include provisioning a second communication service associated with a placeholder account at the NIU. The second communication service may include a default level of services

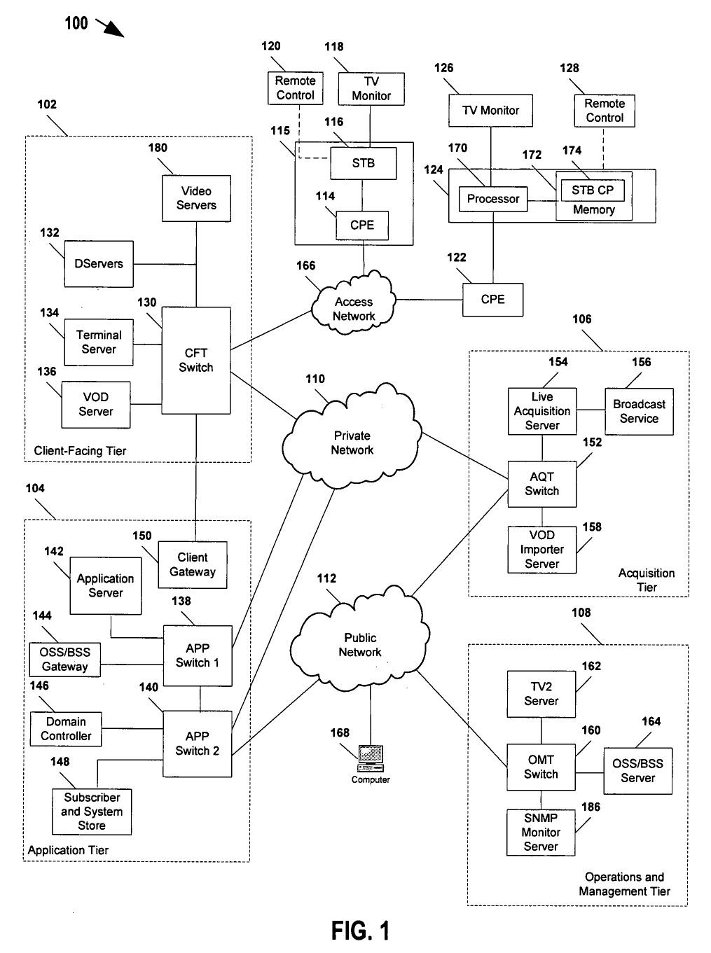

Referring to FIG. 1, an illustrative embodiment of an Internet Protocol Television (IPTV) system that may be used to provide communication services is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 via the first CPE 114 and with a second representative set-top box device 124 via the second CPE 122. In a particular embodiment, the first representative set-top box device 116 and the first CPE 114 can be located at a first customer premise, and the second representative set-top box device 124 and the second CPE 122 can be located at a second customer premise. In another particular embodiment, the first representative set-top box device 116 and the second representative set-top box device 124 can be located at a single customer premise, both coupled to one of the CPE 114, 122. The CPE 114, 122 can include routers, local area network devices, modems, such as digital subscriber line (DSL) modems, any other suitable devices for facilitating communication between a set-top box device and the access network 166, or any combination thereof.

In an exemplary embodiment, the client-facing tier 102 can be coupled to the CPE 114, 122 via fiber optic cables. In another exemplary embodiment, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a point of connection to the IPTV system 100 via the client-facing tier 102. In a particular embodiment, the CFT switch 130 can be coupled to a video-on-demand (VOD) server 136 that stores or provides VOD content imported by the IPTV system 100. Further, the CFT switch 130 is coupled to one or more video servers 180 that receive video content and transmit the content to the set-top boxes 116, 124 via the access network 166.

In an illustrative embodiment, the client-facing tier 102 can communicate with a large number of set-top boxes, such as the representative set-top boxes 116, 124, over a wide geographic area, such as a metropolitan area, a viewing area, a statewide area, a regional area, a nationwide area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that communicates with multiple set-top box devices via a multicast-enabled network.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as interactive program guides, video gaming, display, messaging, processing of VOD material and other IPTV content, etc. In an illustrative embodiment, the application server 142 can provide location information to the set-top box devices 116, 124. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses, stock-keeping unit (SKU) numbers, other identifiers, or any combination thereof, of corresponding set-top box devices 116, 124. In another illustrative embodiment, the subscriber and system store can store data associated with capabilities of set-top box devices associated with particular customers.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer 168 coupled to the public network 112.

In a particular embodiment, functions of the CPE 114 and STB 116 may be combined in a network interface unit (NIU) 115. In such an embodiment, the NIU 115 may be installed at a location, such as a residences or business. The NIU 115 may communicate with the access network 166 to the IPTV system 100, for example, to receive television services. Additionally, the NIU 115 may provide access to other communication services via the access network 166. For example, the NIU 115 may provide access to telephone services; to Voice over Internet Protocol (VoIP) service; to Internet service; to other voice, video or data services available via the private network 110 or the public network 112; or any combination thereof.

In an illustrative, non-limiting embodiment, when power is provided to the NIU 115, the NIU 115 may automatically register with the client gateway 150. The client gateway 150 may identify the NIU 115 based on a unique identifier associated with the NIU 115. The client gateway 150 may communicate with the subscriber and system store 148 to identify the NIU 115, a placeholder account associated with the NIU 115, and first communication services to be provisioned to the NIU 115 based on the placeholder account. For example, the first communication services associated with the placeholder account may include a default, or basic level of services, such as voice, video, audio,.data communications, or any combination thereof. The client gateway 150 may allow the NIU 115 to communicate via the access network 166 to access the first communication services associated with the placeholder account. The first communication services may then be available for use at the NIU 115.

When the first communication services associated with the placeholder account are used or when a communication device is coupled to the NIU 115, the NIU 115, the CFT switch 130, or another device of the system 100, may detect the use, and may send a prompt via the NIU 115 to a user of the first communication service. The prompt may request that the user activate second communication services and provide subscriber account information. The subscriber and system store 148 may set up a subscriber account based on information received from the user, and may associate at least one second communication service with the new subscriber account. The client gateway 150 may authorize the NIU 115 to access the at least one second communication service, and subscriber and system store 148 may deactivate the first communication services and the placeholder account.

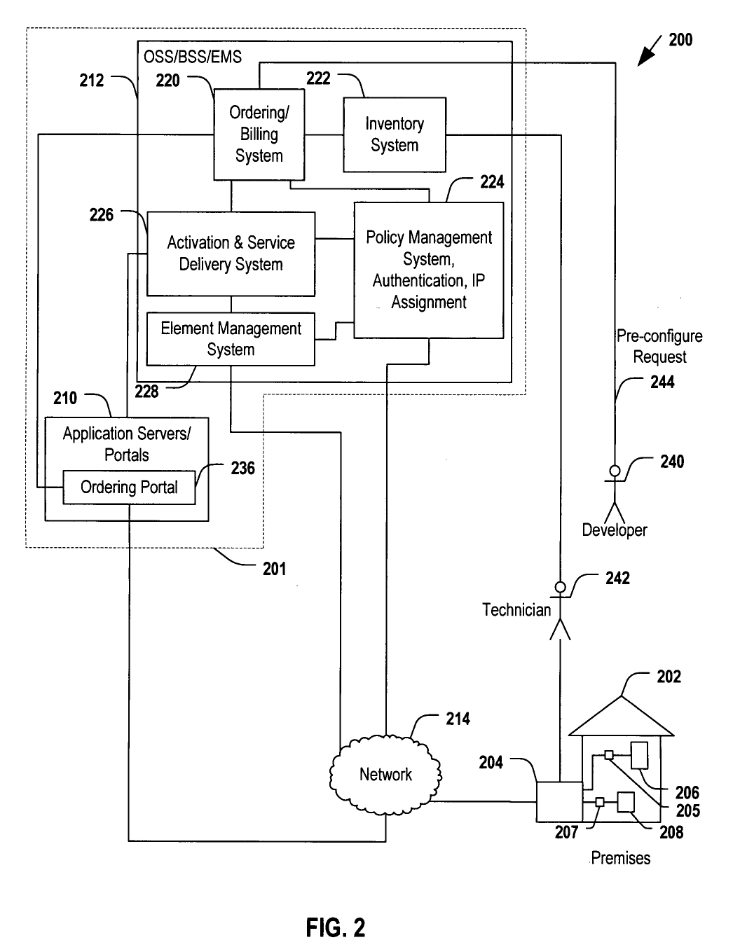

FIG. 2 depicts a second particular embodiment of a system to provide communication services, generally designated 200. The system 200 includes a communication services provider 201 with operation support systems (OSS), billing support systems (BSS), and element management systems (EMS), collectively designated OSS/BSS/EMS system 212. The communication service provider 201 may also include an application servers/portals system 210. The OSS/BSS/EMS system 212 and the application servers/portals system 210 are part of a communication services provisioning system of the communication services provider 201.

In a particular embodiment, the communication services provider 201 provides communication services such as, telephone services, such as Voice over Internet Protocol (VoIP) communications; television services, such as Internet Protocol Television (IPTV) services; Internet services; wireless telephone services; other communication services; or any combination thereof. The communication services may include voice, audio, video, data, or any combination thereof.

In a particular embodiment, the communication services provider 201 may provide communication services to premises 202 via a network interface unit (NIU) 204. The premises 202 may include, for example, a residence or a business. In a particular embodiment, the NIU 204 may be installed as a fixture of the premises 202. The NIU 204 may communicate with one or more communication devices via one or more pre-wired communication interfaces. For example, the NIU 204 may be coupled to a telephone 208 via a telephone interface 207. In another example, the NIU 204 may be coupled to a display device 206 via a display device interface 205. In an illustrative embodiment, the one or more pre-wired communication interfaces may include RJ11 jacks, RJ45 jacks, Universal Serial Bus (USB) ports, Institute of Electrical and Electronics Engineers (IEEE) 1394 ports, serial ports, parallel ports, S-video connectors, composite video connectors, component video connectors, coaxial cable F connectors, other types of communication ports, jacks or connectors, or any combination thereof. In a particular embodiment, a developer 240 (e.g., a homebuilder or commercial real estate developer) may have the NIU 204 installed at the premises 202 when the premises 202 are built. For example, the developer 240 may contact the service provider 201 to provide a technician 242 to install the NIU 204 at a particular time during building of the premises 202. Thus, the NIU 204 may be a fixture of the premises 202 and may include pre-wired communication interfaces to allow communication devices, such as the display device 206 and the telephone 208, to receive communication services via the network 214.

In a particular embodiment, if the premises 202 is a new home, the developer 240 may contact the service provider 201 to provide first communication services at the NIU 204 before the premises 202 is sold. In response to the request, the service provider 201 may provide a technician 242 to install the NIU 204 at the premises 202. The technician 242 may also update an inventory system 222 to indicate that the premises 202 is associated with a particular address, such as a street address, and that the premises 202 is equipped with the NIU 204. Additionally the inventory system 222 may include a unique identifier of the NIU 204 associated with the address of the premises 202. Prior to sale of the premises 202 the developer 240 may send a pre-configuration request 244 to the communication services provider 201.

In a particular embodiment, the pre-configuration request 244 may be received by an operation support system (OSS)/billing support system (BSS) 220. The OSS/BSS 220 may access the inventory system 222 to determine information associated with the premises 202, such as estimated loop bandwidth of a communication loop to the premises 202, and to determine associated resources, such as, a pre-assigned Digital Subscriber Line Access Multiplexer (DSLAM) port, a pre-assigned service access point (SAP), other resources associated with the NIU 204, or any combination thereof. The OSS/BSS 220 may also request activation of new network resources such as a telephone number, etc. In a particular embodiment, the OSS/BSS 220 may also select default communication services based on information that is associated with the premises 202. For example, the OSS/BSS 220 may select VoIP services, other telephone services, Internet services, television services, and so forth. The OSS/BSS 220 may send information related to the pre-configuration request 244, the NIU 204, the premises 202, or any combination thereof, to the activation and service delivery system 226 and the policy management system 224.

In a particular embodiment, the activation and service delivery system 226 may notify an element manager system (EMS) 228 to activate an end-to-end circuit path that includes the NIU 204. Thereafter, first communication services are provided to the premises 202 via the NIU 204.

In a particular embodiment, after power is provided at the premises 202, the NIU 204 may send an authentication message via the network 214 to the policy management system 224 to authenticate the NIU 204 and establish communication with the communication services provider 201 communication systems. This authentication process may associate the NIU 204 with a place holder account established by the element manager system 228 in response to the pre-configuration request 244. In a particular embodiment, the NIU 204 may also request assignment of a public internet protocol (IP) address during the authentication process. The activation and service delivery system 226 may assign the IP address to the NIU 204. Additionally the policy management system 224 may notify the activation and service delivery system 226 to provide the first communication services via the NIU 204.

In a particular embodiment, the first communication services may include a default level of services. In an illustrative embodiment, the default level of services may include lifeline telephone services (e.g., telephone services available to call for emergency assistance), communication services configured to communicate with the communication services provider 201, or other communication services. In a particular embodiment, the first communication services may be limited. For example, the first communication services may only allow communication to particular entities (such as emergency services providers or the communication service provider 201). In another example, the first communication services may be limited in duration (e.g., only available for a predetermined period of time, such as a two-week trial period); may be limited in quantity (e.g., only a certain number of calls may be made using the communication services, or only a certain number of minutes of use may be available); may be limited in quality (e.g., only certain basic communication services may be provided, such as local television channels, or local calls); may be limited in some other manner; or any combination thereof. The policy management system 224 may send a request to the element management system 228 to provision policy settings associated with the first communication services. For example, the element management system 228 may provision an Access Control List (ACL) to identify network addresses accessible using the first communication services (e.g., only the communication service provider's sign in site may be accessible), quality of service (QoS) associated with the first communication services, redirects associated with the first communication services, etc. In a particular embodiment, the NIU 204 may access the element management system 228 via the network 214 to retrieve the policy settings applicable to the NIU 204.

In a particular embodiment, after the premises 202 are sold and a new owner moves in, the new owner may be provided with instructions for activating the communication services at the premises 202. In an illustrative embodiment, the new owner may be provided with an instructions sheet, or one or more of the communication interfaces 205, 207 may include a visual indication indicating to the new owner how to activate the first communication services. For instance, a cover at a communication interface jack may provide instructions for activating the first communication services. In another example, a flyer, sign, sticker or other visual indications associated with the communication interface may provide instructions for activating the first communication services. In an illustrative, non-limiting embodiment, the instructions for activating communication services at the premises 202 may be accompanied by promotional materials, such as a coupon or promotion code providing discounted services or free limited services.

In a particular embodiment, after a communication device is coupled to the NIU 204 via a communication interface 207, the communication device may have immediate access to the first communication services. For example, where the communication device is the telephone 208, the telephone may immediately have access to telephone services associated with the first communication services, such as lifeline telephone services. In a particular embodiment, where the communication device includes a display device 206, the display device may immediately have access to interactive television services or Internet services associated with the first communication services. In an embodiment where the communication device includes a computing device, the computing device may immediately have access to Internet services associated with the first communication services.

In a particular embodiment, when a communication device is coupled to the NIU 204, the NIU 204 or the communication services provider 201 may detect that a communication device has been coupled to the NIU 204 and may send a prompt to the communication device or to another communication device coupled to the NIU 204. For example, when the display device 206 is coupled to the communication interface 205, the NIU 204 may send a user interface display screen to the display device 206. The user interface display screen may prompt a user to activate second communication services with the service provider 201. For example, the user may be prompted to activate a free trial of selected communication services. In an illustrative embodiment, the second communication services may include limited communication services. For example, the second communication services may be limited in duration, quality, quantity, in some other manner, or any combination thereof. In another illustrative embodiment, the second communication services may not be limited. That is, the second communication services may include standard communication services provided by the particular communication service provider 201 in association with a subscriber account. In a particular embodiment, the prompt to activate the second communication services may also include a promotion such as a discount associated with the second communication services.

In a particular embodiment, when the user opts to activate the second communication services, the NIU 204 may send a request to activate the second communication services via the network 214 to the ordering portal 236. In a particular embodiment, the user may also be prompted to provide personal information associated with a subscriber account, such as billing information, credit check information, identification and so forth. After the subscriber information has been provided, the ordering portal 236 may send a request to the OSS/BSS 220 to activate the second communication services. In a particular embodiment, the second communication services may be activated immediately or nearly immediately from the perspective of the user. The second communication services may be associated with a subscriber account based on the subscriber information provided by the user. The subscriber account may be related to the NIU 204 in place of the place holder account with which the NIU 204 was previously associated. Additionally, the policy management system 224 may create and provide a new set of policies associated with the NIU 204 and the element management system 228 may provide the settings and the rules to the communication systems of the communication services provider and to the NIU 204.

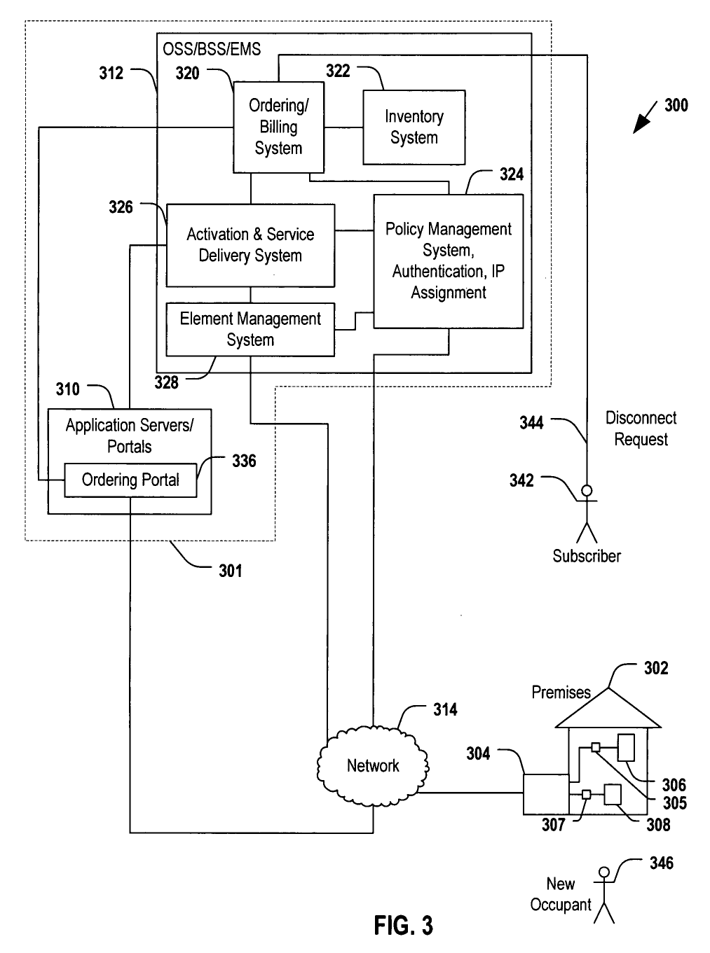

FIG. 3 depicts a third particular embodiment of a system for providing communication services, generally designated 300. The system 300 includes a communication services provider 301 having an order support system (OSS), billing support system (BSS) and element management system (EMS) systems 312 and an application servers/portals system 310. The communication services provider 301 provides communication services to a subscriber 342 at premises 302 via a network 314. The premises 302 include a network interface unit (NIU) 304. The communication services provider 301 provides communication services to the premises 302 via the NIU 304. In an illustrative embodiment, the subscriber 342 has a subscriber account with the communication services provider 301 that includes a unique identifier of the NIU 304.

In a particular embodiment, when the subscriber 342 moves out of the premises 302, the subscriber 342 may request that communication services associated subscriber 342 be disconnected via a disconnect request 344. The OSS/BSS 320 may receive the disconnect request 344 and issue a retain order to the inventory system 322. In response to the retain request, the inventory system 322 may update an inventory database to indicate that a network connection to the NIU 304 is retained; however, communication identifiers associated with the subscriber 342, such as telephone numbers, may be updated as retired. The OSS/BSS 320 may also send a message to an activation and service delivery system 326 to deactivate all communication services at the NIU 304. The OSS/BSS 320 may also send a message to the policy management system 324 directing the policy management system 324 to retire an IP address associated with the NIU 304. The activation and service delivery system 326 may make the communication circuit (e.g., a digital subscriber line loop) to the premises inactive. The OSS/BSS 320 may also generate a final bill associated with the subscriber's account. The OSS/BSS 320 may also request that an instruction sheet indicating how to activate communication services at the premises 302 be automatically generated and mailed to an address associated with the premises 302.

After successful execution of the disconnect request 344, the OSS/BSS 320 may generate a pre-service activation order associated with a place holder account. The OSS/BSS 320 may access the inventory system 322 to retrieve information associated with the premises 302, such as actual loop bandwidth, retained network resources and so forth. The OSS/BSS 320 may also request that new network resources, such as a new phone number or IP address, be associated with the premises 302 and the place holder account. The OSS/BSS 320 may select a set of second communication services to associate with the premises 302. For example, the second communication services may include a default level of service such as, lifeline telephone service, VOIP service, broadband Internet service, television service, and so forth. The OSS/BSS 320 may distribute the order to provision the second communication services to the activation and service delivery system 326 and the policy management system 324. The activation and service delivery system 326 may notify the element management system 328 to make an end-to-end communication path to the residence 302 active.

In a particular embodiment, when a new occupant 346 moves into the premises 302, the new occupant 346 may receive instructions for activating the second communication services. For example, the new occupant 346 may receive the letter automatically generated by the communication services provider 301 in response to the disconnect request 344. In another particular embodiment, the new occupant 346 may receive instructions for activating the second communication services via a visual indication associated with a communication interface coupled to the NIU 304. For example, a telephone interface 307, such as an RJ11 jack, or a computer interface 305, such as an RJ45 jack, may include a cover, sticker, or other visual indication with instructions for activating the second communication services. If the new occupant 346 couples a communication device, such as a telephone 308, or computing device 306, to the NIU 304 via one of the communication interfaces 305, 307, the NIU 304 or the communication services provider 301 may detect that the communication device 306, 308 has been coupled to the NIT 304. In response, the communication services provider 301 or the NIU 304 may send a prompt via the communication device 306, 308 prompting the new occupant 346 to activate third communication services.

In a particular embodiment, the third communication services may be the same as the first communication services (e.g., the first and third communication services may include a typical package of communication services offered by the communication services provider 301), may include more services than the first communication services (e.g., the third communication services may include a deluxe or upgraded set of communication services relative to the first communication services) or may include a limited version of the first communication services (e.g., the third communication services may include communication services limited in duration, quality, quantity or limited in some other manner). For example, the third communication services may include voice, video, audio, data communication services, or any combination thereof.

In a particular embodiment, the prompt presented to the new occupant 346 may include an incentive to activate the third communication services such as a promotional discount or package discount. For example, the third communication services may include a free, limited-time trial offer of the first communication services. In a particular embodiment, presenting the prompt to the new occupant 346, may include automatically calling the telephone 308 after it is coupled to the NIU 304, automatically presenting a user interface display at a display device or computing device 306 after it is coupled to the NIU 304, or automatically presenting any other prompt or any combination of prompts to the occupant 346 based on the: available communication devices. For example, if the telephone 308 and the computing device 306 are coupled to the NIU 304, a display may be presented at the display device 306 and an automatic telephone call may be sent to the telephone 308 each of which may include a prompt to activate the third communication services.

In a particular embodiment, if the new occupant 346 elects to activate the third communication services, the new occupant 346 may send a request via the communication device from which the prompt was received or via another communication device coupled to the NIU 304 to the ordering portal 336. The ordering portal 336 may gather subscriber information from the new occupant 346, such as, credit check information, identification, payment information, etc. The ordering portal 336 may send the request to activate the third communication services and the subscriber information to the OSS/BSS 320. The OSS/BSS 320 may validate the information provided by the new occupant 346 and may generate a new subscriber account associated with the new occupant 346. The OSS/BSS 320 may also access the inventory system 322 to associate communication services provided to the premises 302 with the new subscriber account. The activation and service delivery system 326 may activate the third communication services at the NIU 304. The policy management system 324 may create a new set of policies and request the element management system to provision the new policies and settings associated with the third communication services and the new user account to the NIU 304.

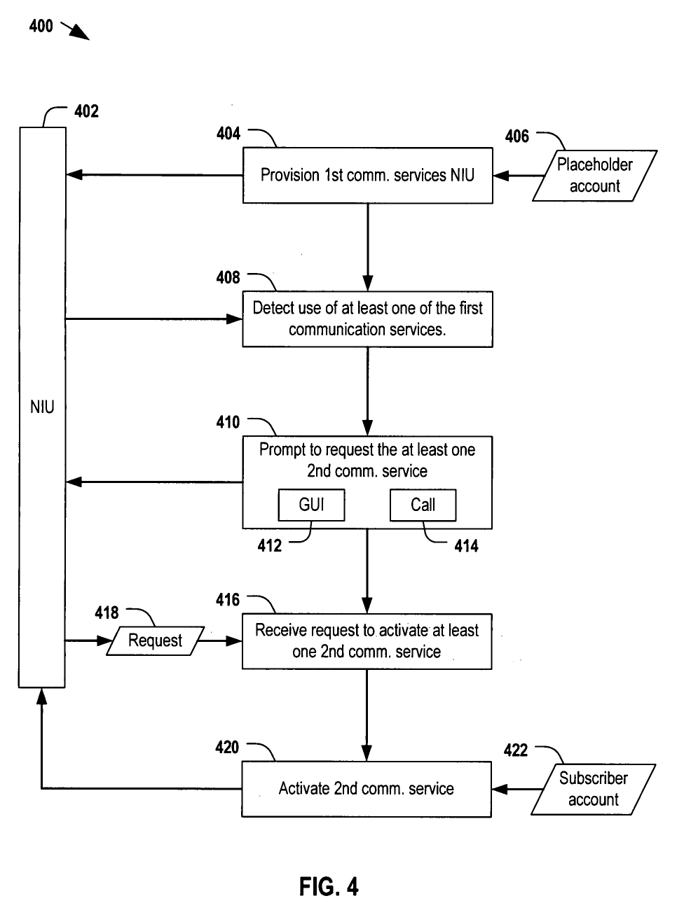

FIG. 4 depicts a first particular embodiment of a flow diagram of a method of providing communication services, generally designated 400. The method 400 includes, at 404, provisioning first communication services at a network interface unit (NIU) 402. In a particular embodiment, the NIU 402 is associated with a particular premises, such as a residence. In the method 400, the first communication services may be associated with a placeholder account 406.

In a particular embodiment, the placeholder account 406 may be a dummy account. That is, the placeholder account may not be associated with an actual communication services subscriber. For example, the placeholder account 406 may include default information assigned by a communication services provider to identify the placeholder account 406 as a dummy account and to allow services to be associated with the placeholder account 406. In an illustrative embodiment, the communication services provider may have administrative support systems, such as an operation support system (OSS) and billing support system (BSS) that require services provided to premises to be associated with a subscriber account. The placeholder account may allow the first communication services to be provided without requiring specific subscriber information. Thus, first communication services may be made available at premises which are not associated with a subscriber account, such as an unoccupied or newly occupied residence, without requiring changes in the administrative support systems.

In an illustrative embodiment, the first communication services may include, for example, emergency telephone services, telephone, television, or Internet services, Internet protocol television (IPTV) services, other voice, audio, video or data communication services, or any combination thereof. In a particular illustrative embodiment, the first communication services may be limited, that is the first communication services may not provide complete access to communication services that may be associated with a typical subscriber account. For example, the first communication services may be limited in duration, quality, quantity, in some other manner, or any combination thereof. That is, the first communication services may include a default level of services. The specific services and level of service of the first communication services may vary from place to place, from time to time, in other ways, or any combination thereof. For example, a particular developer may desire a high level of service to be associated with properties he or she has developed. Thus, the developer may request that the first communication services include more services or a higher level of services than the default level of services. In another example, the first communication services may include particular services or levels of service to comply with local requirements. Thus, if a particular jurisdiction requires that emergency telephone services be available at all premises, the first communication services may include emergency telephone services in that jurisdiction.

The method 400 also includes, at 408, detecting use of at least one of the first communication services. For example, one or more communication interface may be pre-wired to the NIU 402. The method 400 may include detecting a when a communication device is couple to the NIU 402 via one of the pre-wire communication interfaces. In a particular embodiment, since the first communication services are associated with the place holder account 406, the use of the first communication services detected, at 408, may not be used by a subscriber. That is, the user of the first communication services is not a subscriber to the first communication services.

The method 400 also includes, at 410, prompting the user of the first communication services to request at least one second communication service. In a particular embodiment, the at least one second communication service may include limited communication services or standard communication services (e.g., communication services provided to communication service subscribers). In a particular embodiment, the second communication services may include telephone, television, IPTV, Internet services, other voice, video or data services, or any combination thereof. In a particular embodiment, the second communication services may be associated with a subscriber account. For example, the prompt may include a prompt to provide subscriber account information from the user of the first communication services. In a particular embodiment, the prompt may be presented, for example, via a telephone call 414 to telephone connected to the NIU 402. In a particular embodiment, the prompt may include a graphical user interface (GUI) 412 displayed at a display device coupled to the NIU 402. In a particular embodiment, the prompt may be generated automatically in response to detecting the use of the first communication services.

In a particular embodiment, the method 400 may include, at 416, receiving a request 418 to activate at least one second communication service. For example, the request 418 to activate the at least one communication service may be received via a communication device coupled to the NIU 402 using first communication services. In a particular illustrative embodiment, the request 418 may be received by at least one of telephone service, Internet service, or interactive television service provided via the NIU 402.

In a particular embodiment, the method 400 may also include, at 420, activating the requested at least one second communication service. Activating the at least one second communication service may include gathering information associated with a subscriber account 422 and associating the at least one second communication service with the subscriber account 422 and the NIU 402.

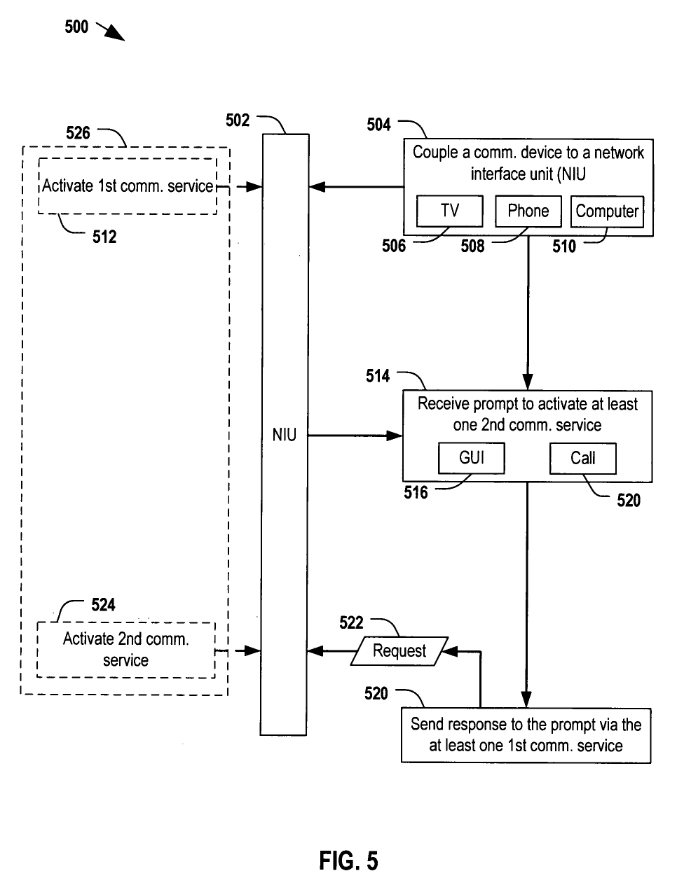

FIG. 5 depicts a second particular embodiment of a method of providing communication services, generally designated 500. The method 500 includes, at 504, coupling a communication device to a network interface unit (NIU) 502. For example, the communication device may include a display device, such as a television 506; a voice communication device, such as a telephone 508 or a Voice over Internet Protocol (VOIP) device; or a computing device such as a computer 510. In a particular embodiment, the communication device may be coupled to the NIU 502 via one or more pre-wired communication interfaces. In an illustrative embodiment, at least one of the communication interfaces may be associated with instructions for accessing communication services via the communication interface.

In a particular embodiment, when a communication device is coupled to the NIU 502, at least one first communication service may be activated at the communication device, at 512. For example, when the telephone 508 is plugged in to a telephone jack coupled to the NIU 502, telephone services associated with the first communication services may be activated at the telephone 508. In another example, when the television 506 is coupled to a television interface connected to the NIU 502, television services associated with the first communication services may be activated at the television 506. In another example, when the computer 510 is coupled to a communication interface coupled to the NIU 502, Internet services may be activated at the computer 510.

The method 500 also includes, at 514, receiving a prompt to activate at least one second communication service. For example, the prompt to activate the at least one second communication services may be presented via a graphical user interface (GUI) 516 displayed at a display device or computing device or via a voice communication such as a telephone call 520 presented via a voice communication device coupled to the NIU 502.

The method 500 may also include, at 520, sending a request 522 in response to the prompt via the at least one first communication service. For example, when the first communication service includes telephone service, the prompt may be presented via voice communication such as the call 520 and the request 522 may be sent via the NIU 502 to the communication services provider 526 via a voice response. A communication services provider 526 may activate the second communication services, at 524, in response to the request 522.

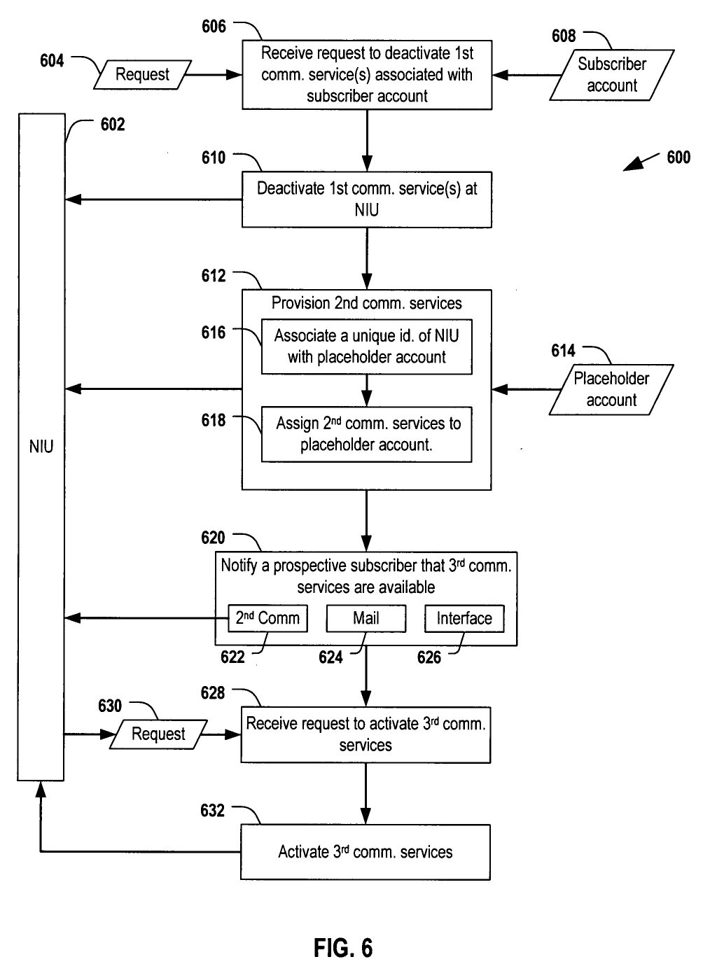

FIG. 6 depicts a third particular embodiment of a method of providing communication services, generally designated 600. The method 600 includes, at 606, receiving a request 604 to deactivate first communication services associated with a subscriber account 608. The subscriber account may be associated with a particular location, such as the subscriber's residence.

The method 600 may also include, at 610, deactivating the first communication services at a network interface unit (NIU) 602 in response to the request 604. After deactivating the first communication services, the method 600 may include, at 612, provisioning second communication services associated with a placeholder account 614 at the NIU 602. In a particular embodiment, the second communication services may include a default level of services. For example, the second communication services may include lifeline telephone services, communication services that provide access to a communication services provider, other voice, video or data services, or any combination thereof. In a particular embodiment, provisioning the second communication services may include, at 616, associating a unique identifier of the NIU 602 with the place holder account 614, and, at 618, assigning the second communication services to the place holder account 614.

In a particular embodiment, the method 600 may also include, at 620, notifying a prospective subscriber that third communication services are available at the location. For example, the prospective subscriber may be notified via mail 624, via a notice provided at a pre-wired communication interface 626, or via the second communication services 622. The notice to the prospective subscriber that the third communication services are available may include an incentive to subscribe to the third communication services. For example, the notice to the prospective subscriber may include an offer to discount communication services or a limited-time free trial offer of the communication services.

In a particular embodiment, the method 600 may include, at 628, receiving a request 630 to activate the third communication services. In a particular embodiment, the third communication services may include a limited activation of the first communication services. For example, the third communication services may include communication services that are limited in duration, quantity, quality, limited in another manner, or any combination thereof. In a particular embodiment, the request to activate the third communication services may be provided via the second communication services. For example, the second communication services may provide assess to communicate via telephone to a communication service provider, and the prospective subscriber may call the communication service provider, using the second communication services, to activate the third communication services. In a particular embodiment, the method 600 may also include, at 632, activating the third communication services in response to the request 630.

In conjunction with the configuration of structure described herein, the systems and methods disclosed provide communication services. In a particular illustrative embodiment, first communication services are provisioned at a network interface unit (NIU) associated with a premises. The first communication services are associated with a placeholder account by an OSS/BSS of a communication services provider. A request to activate at least one second communication service may be received by the communication services provider via at least one of the first communication services. The communication services provider may automatically activate the at least one second communication service.

In particular embodiments, the communication services may include so called “triple play” communication services, including voice, video, and data services. The methods and systems disclosed may provide an inexpensive alternative for communication services providers to attract new customers and to retain customers. Additionally, the methods and systems disclosed may allow communication services to be immediately available when a new occupant moves into a location without requiring a visit from a technician to install services. This may provide for an improved customer experience as well as the cost savings associated with not having to send out technician.

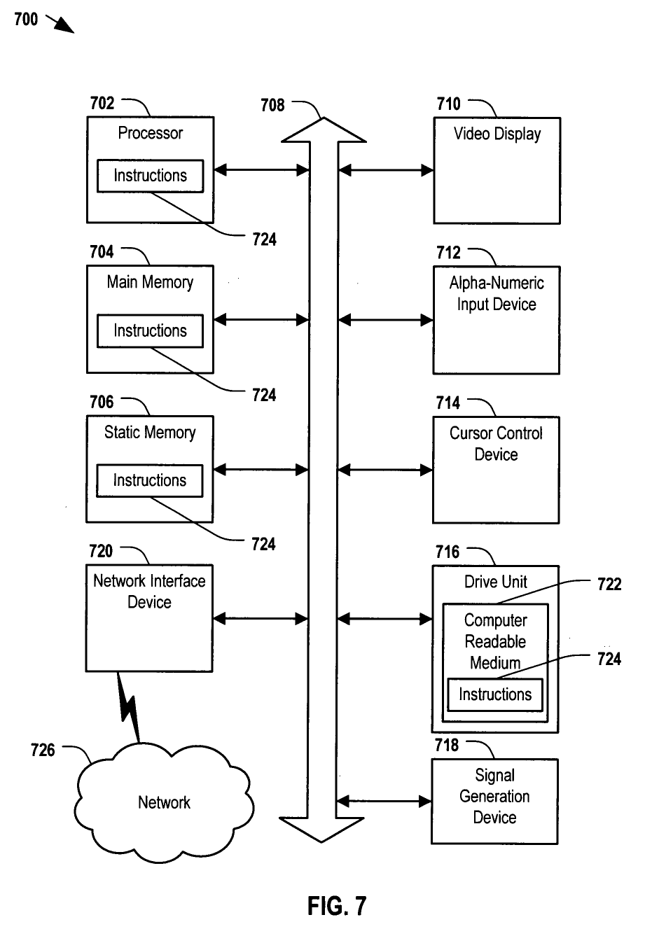

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices. In particular embodiments, the computer system 700 may include any one or more of the communication service provider system devices, Internet Protocol Television (IPTV) system devices, network devices, network interface units (NIUs), or communication devices illustrated and described with reference to FIGS. 1-6.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 704 and a static memory 706, that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing communication services, the method comprising:
provisioning at least one first communication service at a network interface unit (NIU) associated with a premises, wherein the at least one first communication service is associated with a placeholder account;
receiving, via the at least one first communication service, a request to activate at least one second communication service; and
automatically activating the at least one second communication service.

2. The method of claim 1, wherein the at least one first communication service includes emergency telephone service.

3. The method of claim 1, wherein the at least one first communication service includes at least limited telephone, television and Internet services.

4. The method of claim 1, wherein the at least one first communication service includes an Internet Protocol Television (IPTV) service.

5. The method of claim 1, wherein the at least one second communication service includes at least limited telephone, television and Internet services.

6. The method of claim 1, wherein the at least one second communication service is associated with a subscriber account at activation.

7. The method of claim 1, wherein the placeholder account is not associated with a particular subscriber.

8. The method of claim 1, wherein the premises includes a plurality of communication interfaces pre-wired to the NIU, and wherein an indication of the availability of the at least first communication service is associated with at least one of the communication interfaces.

9. The method of claim 1, further comprising prompting a user to request the at least one second communication service after detecting use of the at least one first communication service.

10. The method of claim 9, wherein prompting the user includes automatically communicating with the user after a communication device is coupled to the NIU.

11. The method of claim 9, wherein prompting the user includes calling the user at the premises after a telephone is coupled to the NIU.

12. The method of claim 9, wherein prompting the user includes presenting a user interface at a display device coupled to the NIU, wherein the user interface includes a prompt to request the at least one second communication service.

13. The method of claim 1, further comprising:
prompting a user of the at least one first communication service to set up a subscriber account;
receiving subscriber account information from the user;
setting up a new subscriber account based on the subscriber account information;
deactivating the at least one first communication service and the placeholder account; and
associating the at least one second communication service with the new subscriber account.

14. The method of claim 1, wherein the request for the at least one second communication service is received via at least one of a telephone service, an Internet service, and an interactive television service.

15. The method of claim 1, wherein the premises includes a recently occupied residence.

16. The method of claim 1, wherein the first communication services include a default level of services.

17. A method of providing communication services, the method comprising:
coupling a communication device to a network interface unit (NIU) at a location associated with the NIU, wherein coupling the communication device to the NIU activates at least one first communication service;
receiving a prompt to activate at least one second communication service; and
sending a response to the prompt via the at least one first communication service, the response including a request to activate the at least one second communication service.

18. The method of claim 17, wherein the communication device comprises a telephone.

19. The method of claim 17, wherein the communication device comprises a display device.

20. The method of claim 17, wherein the communication device comprises a computing device.

21. The method of claim 17, wherein coupling the communication device to the NIU comprises connecting the communication device to a pre-wired communication interface at the location associated with the NIU.

22. A method of providing communication services, the method comprising:
receiving a request to deactivate at least one first communication service associated with a subscriber account;
deactivating the at least one first communication service at a network interface unit (NIU); and
provisioning a second communication service associated with a placeholder account at the NIU, wherein the second communication service includes a default level of services.

23. The method of claim 22, wherein the second communication service only allows communication to a communication services provider associated with the NIU.

24. The method of claim 22, wherein provisioning the second communication service comprises associating a unique identifier of the NIU with the placeholder account and assigning the second communication services to the placeholder account.

25. The method of claim 22, further comprising activating a third communication service in response to a request sent via the NIU.

26. The method of claim 25, wherein the third communication service includes a limited activation of the first communication services.

27. The method of claim 22, further comprising notifying a prospective subscriber at a premises associated with the NIU that the third communication service is available via the NIU.

28. The method of claim 27, wherein the prospective subscriber is notified via mail.

29. The method of claim 27, wherein the prospective subscriber is notified via a notice at an interface pre-wired to the NIU.

30. The method of claim 27, wherein notifying the prospective subscriber that the third communication service is available includes providing a promotional code to the prospective subscriber, wherein the promotional code is usable to activate at least limited use of the third communication service at a discounted price.
